(19) United States
(12) Patent Application Publication
(10) Pub. No.: US 2026/0179151 A1
(43) Pub. Date: Jun. 25, 2026

(54) TRAINING AND APPLYING A PARALLEL-STRUCTURED NEURAL NETWORK FOR DENIAL PREVENTION

(71) Applicant: MedeAnalytics, Inc., Richardson, TX (US)

(72) Inventors: Petro KRASNIATOV, Poznan (PL); Matthew Hanauer, Richardson, TX (US); MariBeth Jenkins, Lee's Summit, MO (US); Jeremiah Chronister, McKinney, TX (US); David Schweppe, Walnut Creek, CA (US); Christine Carol Smith Stetler, Decatur, IN (US); Brenda Turner, Trenton, NJ (US)

(73) Assignee: MedeAnalytics, Inc., Richardson, TX (US)

(21) Appl. No.: 19/424,842

(22) Filed: Dec. 18, 2025

Related U.S. Application Data
(60) Provisional application No. 63/736,087, filed on Dec. 19, 2024.

(51) Int. Cl. G06Q 40/08

(52) U.S. Cl. CPC G06Q 40/09

(57) ABSTRACT

Embodiments relate to training and applying a parallel-structured neural network. In some embodiments, a dataset of a plurality of claims is received, where each claim of the plurality of claims includes multiple fields. Features, including numerical features and a plurality of categorical features, are extracted from the plurality of claims and based on the multiple fields. The parallel-structured neural network is trained by (1) selecting, based on a feature selection algorithm and a loss function, one or more numerical features and one or more categorical features, and (2) generating, based on the selected features, a categorical layer, a fully-connected layer, and a concatenation layer of the parallel-structured neural network. A claim is received including numerical data and categorical data, and a probability prediction is generated by inputting the claim into the parallel-structured neural network. Finally, a submission including the first claim is generated based on the probability prediction.

### BRIEF SUMMARY

Healthcare providers (e.g., hospitals) submit claims (e.g., MRI, vaccines) that insurance companies review and sometimes deny for various reasons. Denials can cost providers millions, and sometimes billions, of dollars in lost or delayed revenue. Current methodologies to avoid claim denial typically involves: (1) expert intervention; or (2) a rule-based approach. Expert intervention usually involves a trained person reviewing the claim and identifying whether they believe it will be denied. These experts can quickly identify easy mistakes; however, they may not know all updated rules for all insurance providers. Additionally, there may be unwritten rules or policies within an insurance company that would be difficult for a human reviewer to detect. Given the amount of time it takes for experts to review each claim, some companies have developed rules based systems. These systems attempt to automate both the expert knowledge described above and rules provided by the insurance companies. However, rule-based systems need to be constantly updated with the latest rules and regulations. Thus, there is a need for a more efficient system to analyze claim data in order to provide a useful and accurate prediction of whether the claim will be denied.

### BRIEF DESCRIPTION OF THE DRAWINGS

The accompanying drawings are incorporated herein and form a part of the specification.

FIG. 1 is a flowchart illustrating an example process for a denial process, according to some embodiments.

FIG. 2 is a flowchart illustrating a process for calculating a denial probability using a denial avoidance probability estimator, according to some embodiments.

FIG. 3 is a flowchart illustrating a process for predicting a time to adjudication using a time to adjudication estimator, according to some embodiments.

FIG. 4 is a flowchart illustrating a process for predicting a remark code using a remark code prediction system, according to some embodiments.

FIG. 5 is a flowchart illustrating a process for training and applying a parallel-structured neural network, according to some embodiments.

FIG. 6 is a flowchart illustrating a process for training a parallel-structured neural network, according to some embodiments.

FIG. 7 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method, and/or computer program product embodiments, and/or combinations and sub-combinations thereof, for training and applying a parallel-structured neural network that can be used, for example, to predict whether a claim will be denied. Embodiments may include four models, including: (1) denial prediction; (2) successful re-adjudication prediction; (3) time to adjudication; and (4) reason and remark code predictions. In some embodiments, a system may receive a dataset of a plurality of claims, where each claim of the plurality of claims may include a plurality of fields. The system may extract, from the plurality of claims and based on the plurality of fields, a plurality of features, wherein the plurality of features includes a plurality of numerical features and a plurality of categorical features. The system may then train, based on a feature selection algorithm and a loss function, the parallel-structured neural network on the plurality of claims. The system's training may be performed by: (1) selecting, based on the feature selection algorithm and the loss function, one or more numerical features of the plurality of numerical features and one or more categorical features of the plurality of categorical features and (2) generating, based on the selected one or more numerical features and the selected one or more categorical features, a categorical layer, a fully-connected layer, and a concatenation layer of the parallel-structured neural network. The system may receive, such as at run-time, a claim including numerical data and categorical data. In response, the system may generate a probability prediction by inputting the first claim into the parallel-structured neural network and generate, based on the probability prediction, a submission including the first claim.

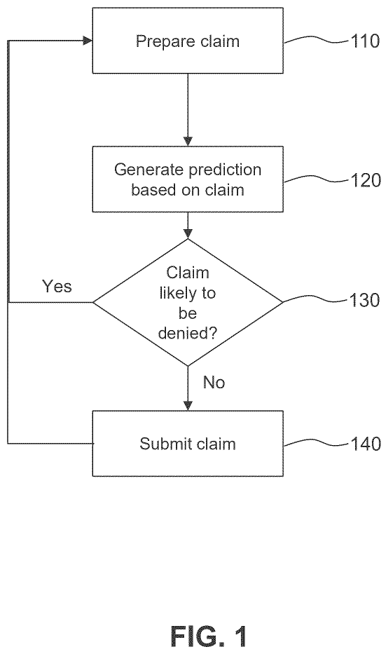

FIG. 1 is a flowchart illustrating process 100 for using a denial suite, according to some embodiments. Process 100 shall be described with reference to FIG. 1, however, process 100 is not limited to that example embodiment.

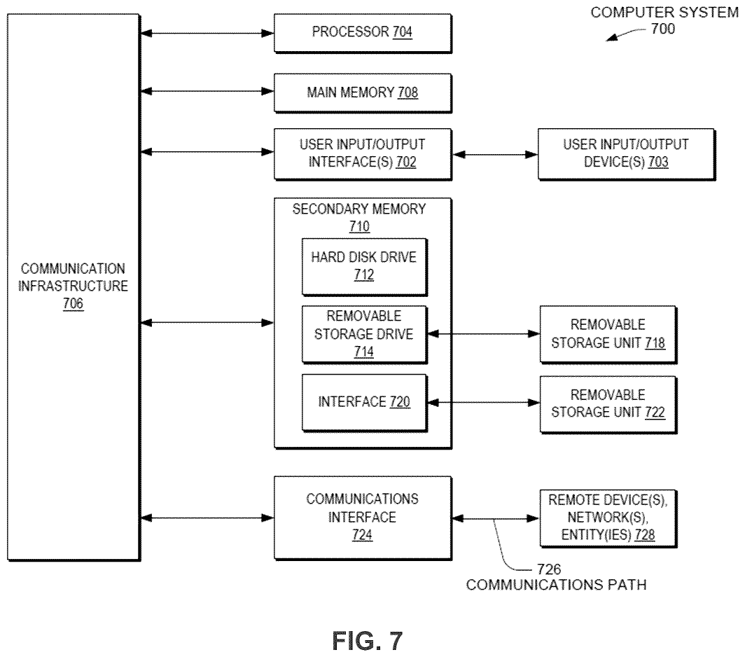

Process 100 may be executed on any computing device, such as, for example, the exemplary computer system described with reference to FIG. 7. Process 100 may be performed by processing logic that may comprise hardware (e.g., circuitry, dedicated logic, programmable logic, microcode, etc.), software (e.g., instructions executing on a processing device), or a combination thereof.

In some embodiments, one or more of the steps shown in FIG. 1 may be omitted, repeated, performed simultaneously, and/or performed in a different order than the order shown in FIG. 1. Accordingly, the scope of the invention should not be considered limited to the specific arrangement of steps shown in FIG. 1. The steps shown in FIG. 1 may be implemented as computer-readable instructions stored on computer-readable media, where, when the instructions are executed, cause a processor to perform the process of FIG. 1.

At 110, the denial suite prepares a claim. As will be discussed below, preparing a claim may involve: (1) data preparation; (2) feature engineering; (3) feature encoding; and (4) data aggregation. A claim may include various data points including: (1) claim group key; (2) Current Procedural Terminology (CPT)/Healthcare Common Procedure Coding System (HCPCS) code; (3) Patient Type Dimension (e.g., PTTypeDim); (4) claim bill date; (5) discharge date; (6) facility type; (7) patient status; (8) type of bill; (9) primary diagnosis; (10) charge amount; (11) patient age; (12) length of stay; (13) patient sex; (14) primary payor; (15) secondary payor; (16) tertiary payor; (17) current payor; (18) current payor type; (19) revenue code; (20) insurance plan primary (e.g., PASInsPlan1); (21) diagnosis (e.g., OTHRDX1); (22) attending physician identifier; (23) modifier; (24) attending physician specialty; (25) relatedDxCount; (26) diagnosis complexity flag; (27) admitting diagnosis; (28) denial; (29) check date; (30) claim status; (31) claim identifier; and (32) reason code.

Patient Type Dimension may indicate whether the treatment corresponding to the claim was inpatient or outpatient. In some embodiments, a claim may include multiple diagnoses. Each diagnosis may correspond to an entry labelled, for example, OTHRDX. For example, a first diagnosis may be listed under OTHRDX1, and a second diagnosis may be listed under OTHRDX2. A modifier may be inserted to justify the use of a procedure that is not standard for the diagnosis.

At 120, the denial suite generates a prediction based on the claim. The denial suite may use one or more machine learning models to generate the prediction. The prediction may include various outputs including, but not limited to: (1) CPT code; (2) resubmission denial avoidance probability; (3) full denial avoidance probability; (4) fallback denial probability; (5) fallback approval probability; (6) absolute avoidance probability difference; (7) final avoidance probability; (8) predicted time to payment; (9) denial probability; (10) reason; and (11) reason code probability.

At 130, the denial suite evaluates the prediction. If a determination is made that the claim is likely to be denied, process 100 returns to step 110. Process 100 may return to step 110 to edit and/or revise the claim to increase the likelihood it will be accepted. If a determination is made that the claim is likely to be accepted, process 100 proceeds to step 140.

At 140, the denial suite submits the claim. The claim may be submitted, for example, to an insurance provider. In some embodiments, the claim may be denied. In such a case, the denial suite may return to step 110 and prepare the claim for resubmission. In some embodiments, the claim may be accepted. In such a case, the denial suite may return to step 110 and prepare a subsequent claim for submission.

As noted above, the denial suite may include a denial avoidance probability estimator. The denial avoidance probability estimator may be designed to predict the likelihood of a healthcare insurance claim being denied and the probability of successful resubmission. In some embodiments, the estimator may use two models, one for denial prevention (e.g., for new claims) and one for resubmission (e.g., for claims that have been denied and are submitted again). These models may use machine learning to analyze past claims and predict future outcomes. In some embodiments, the denial avoidance probability estimator may use a single model for both new claims and resubmitted claims.

Both the denial prevention and resubmission models may use a similar architecture. In some embodiments, the denial prevention and resubmission models may use different architectures. In some embodiments, the denial prevention and resubmission models may be trained on different datasets. In some embodiments, the denial prevention and resubmission models may be trained on the same dataset. The denial prevention and resubmission models may include a categorical input layer. The categorical input layer may input features (e.g., facility type, diagnosis) that are processed through an embedding or lookup layer, and convert them into vectors for the neural network.

The categorical input layer may receive categorical variables (e.g., facility type, diagnosis codes). A categorical variable may include a type and a value. For example, a type may be “facility type,” and the value may be “hospital.” The categorical input layer convert each unique categorical value into a numerical value. For example, the type may be “hospital type” and possible values may include “acute care” and “ambulatory.” Here, the categorical input layer may assign each instance of “acute care” to 1, and each instance of “ambulatory” to 2. The categorical input layer may then input the numerical values to an embedding layer. The embedding layer may be configured to transform each categorical value into a dense vector of real numbers. The dense vector of real numbers may be configured such that the semantic meaning of the original value (e.g., acute care, ambulatory) is maintained. For example, similar categorical values (e.g., emergency room, urgent care) may have more similar dense vectors of real numbers than dissimilar categorical values (e.g., outpatient clinic, emergency surgery). Finally, the embedded vector (e.g., the dense vector of real numbers) may be concatenated with other numerical features, such as patient age, before being input to additional layers of the neural network. This eliminates the need for conventional one-hot encoding or embedding layers, reducing dimensionality and computational complexity when handling high-cardinality categorical data, and allowing capture of relationships between categories not easily possible using one-hot encodings.

The denial prevention and resubmission models may further include a numerical input layer. The numerical input layer may input features (e.g., patient age, charge amount), which are fed through a separate dense (e.g., fully connected) layer. The denial prevention and resubmission models may include a concatenation layer. The concatenation layer may input both categorical and numerical inputs then combine them into a single layer for final processing.

By using parallel neural network branches for categorical and numerical data, each branch can specialize in its particular data type, allowing the neural network to learn more effectively than in a traditional single-branch architecture. In conventional single-branch architectures, categorical embeddings and continuous features are forced through identical transformation layers, resulting in gradient competition where updates optimized for one data type may degrade learned representations of the other. The parallel-branch architecture of the present invention allows independent gradient flow, enabling each pathway to converge at rates appropriate to its respective feature space without interference.

Furthermore, categorical data and numerical data possess fundamentally different distributional properties, with categorical data being sparse and high-dimensional after encoding, while numerical data remains dense and continuous. A unified single-branch architecture applies homogeneous transformations that may compress or distort type-specific information before meaningful feature interactions can occur. The parallel processing approach of the present invention preserves the native structure of each data type through specialized layers prior to fusion, thereby maintaining representational fidelity.

Additionally, the parallel architecture enables each branch to employ activation functions, normalization strategies, and layer depths optimized for its input characteristics. For example, different regularization approaches may be applied for high-cardinality categorical features versus bounded numerical ranges. The fusion point may be strategically positioned to control when cross-type interactions are learned, providing additional architectural flexibility not available in single-branch approaches.

Moreover, by integrating processed categorical and numerical data within parallel neural network branches, the model effectively learns from both data types in a scalable and innovative manner. Branch complexity scales independently with the dimensionality and complexity of each data type, and new categorical or numerical features may be incorporated without rebalancing the entire architecture.

The denial prevention and resubmission models may include an output layer. The output layer may include an activation function (e.g., a sigmoid function) to produce a probability score. The probability score may represent the likelihood that the claim will be successfully processed (or successfully resubmitted).

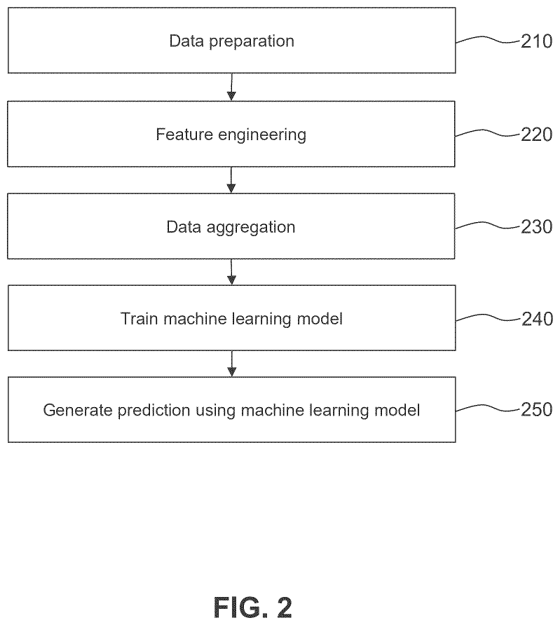

FIG. 2 is a flowchart illustrating process 200 for calculating a denial probability using a denial avoidance probability estimator, according to some embodiments. Process 200 shall be described with reference to FIG. 2, however, process 200 is not limited to that example embodiment.

Process 200 may be executed on any computing device, such as, for example, the exemplary computer system described with reference to FIG. 7. Process 200 may be performed by processing logic that may comprise hardware (e.g., circuitry, dedicated logic, programmable logic, microcode, etc.), software (e.g., instructions executing on a processing device), or a combination thereof.

In some embodiments, one or more of the steps shown in FIG. 2 may be omitted, repeated, performed simultaneously, and/or performed in a different order than the order shown in FIG. 2. Accordingly, the scope of the invention should not be considered limited to the specific arrangement of steps shown in FIG. 2. The steps shown in FIG. 2 may be implemented as computer-readable instructions stored on computer-readable media, where, when the instructions are executed, cause a processor to perform the process of FIG. 2.

At 210, the denial avoidance probability estimator prepares claim data for analysis. Both models (denial and resubmission) may use the same initial data preparation process to ensure the input data is clean and standardized. Preparing claim data for analysis may include a data cleaning step, a data transformation step, and grouping claims. Data cleaning may involve removing incomplete or missing data (e.g., claim date or patient age). Data transformation may include converting data into an appropriate format, such as dates, numeric values, and categorical codes. For example, patient age may be converted into an integer, and procedure codes (e.g., current procedural terminology (CPT) codes) may be standardized. Claim grouping may include assigning claims to groups based on identifiers (e.g., patient account number and claim ID). This grouping is beneficial for analyzing the full claim history, including the initial submission and any resubmissions.

In some embodiments, a clean plurality of claims is generated by adding one or more required fields to a subset of claims of the plurality of claims. Each of the subset of claims may be missing the one or more required fields. And, in some embodiments, a standardized plurality of claims may be generated by converting one or more fields of one or more claims of the clean plurality of claims to a standardized format.

At 220, the denial avoidance probability estimator executes a feature engineering step. Feature engineering may be used to create features. Features may be data points used by a model to make predictions. For example, the denial avoidance probability estimator may extract features from the data as part of feature engineering. Features may include: (1) patient information; (2) claim details; and (3) claim history. Patient information may include age, status, type of facility, and payor type. Claim details may include date of service, procedure codes (e.g., CPT codes), diagnosis, and the amount billed. Claim history may include information about whether the claim was previously denied or successfully processed.

Features may be grouped into categorical features and numerical features. Categorical features may include non-numeric data points such as facility type, patient status, and diagnosis codes. Categorical features may be converted into numerical representations (e.g., through indexing) for model input. Numerical features may include continuous values such as a charge amount or a patient age. Numerical features may be standardized (e.g., scaled) to ensure uniformity across the dataset.

At 230, the denial avoidance probability estimator executes a data aggregation step. For each claim, the denial avoidance probability estimator may aggregate historical information to understand the pattern of claim submissions and denials. This is important because: (1) claims with inconsistent statuses or procedures are removed from the dataset to avoid incorrect predictions; and (2) historical data allows the system to track the “journey” of a claim, from its initial denial to its resubmission and resolution. For resubmitted claims, the denial avoidance probability estimator may compare the initial and final denial status to see if the denial was avoided. This information is useful for training the model on what makes a resubmission successful.

As noted above, the denial avoidance probability estimator may include two models—one for new claims (e.g., a denial model) and one for resubmitted claims (a resubmission model). Thus, at each step in process 200 described above, the denial model may perform steps of process 200 for new claims, and the resubmission model may perform steps of process 200 for claims being resubmitted.

At 240, the denial avoidance probability estimator trains a machine learning model. The denial avoidance probability estimator may train the denial model and the resubmission model. The models may be trained separately, using historical claim data with known outcomes (e.g., whether they were denied or successfully processed). The training process may involve: (1) feature selection; (2) loss function; and (3) training and validation. Feature selection may use categorical and numerical features from the cleaned and aggregated dataset. The loss function may be a binary cross-entropy function to optimize the model. The binary cross-entropy function may be configured to output a probability. Training may involve training on a large portion of the dataset. The model may be validated on a separate dataset to prevent overfitting.

At 250, the denial avoidance probability estimator generates a prediction. Noted above, denial avoidance probability estimator may include a denial model for new claims, and a resubmission model for resubmitted claims. Here, the denial avoidance probability estimator may use the denial model to predict whether a new claim will be denied. Similarly, the denial avoidance probability estimator may use the resubmission model to predict whether a resubmitted model will be denied. In some embodiments, both models may generate a denial avoidance probability score, indicating the likelihood of a claim avoiding denial.

The denial suite may further include a time to adjudication estimator configured to predict a time to adjudication. The time to adjudication estimator may be configured to predict a time from when the claim is submitted to when it is paid or denied. In some embodiments, the time to adjudication estimator may use a single model to predict both time to payment and time to denial. In some embodiments, the time to adjudication estimator may have one model configured to predict a time to payment, and a separate model configured to predict a time to denial. The time to adjudication estimator may use machine learning techniques to analyze historical claim data and predict outcomes for new claims.

The time to adjudication estimator may include a machine learning model including a deep learning architecture to process the data. The deep learning architecture may include multiple layers. In some embodiments, each layer may be responsible for handling different types of features. The model may include an input layer. The input layer may be configured to receive numerical data including fields such as “chargeamount” (an amount billed), “los” (length of stay), and “ptage” (patient age). The input layer may be further configured to receive categorical data. Categorical data may include fields such as “facilitytype,” “primarydiagnosis,” and “revenuecode.” In some embodiments, categorical data may be processed through an embedding and/or lookup layers, configured to convert categorical data into numerical vectors for input into the model.

The model may further include a hidden layer. The model may include any number of hidden layers. The hidden layer(s) may be configured to apply one or more transformations and learn patterns within the data. In some embodiments, the model may include multiple hidden layers that are fully connected (e.g., dense). The model may further include an output layer. The output layer may generate a regression prediction. The regression prediction may include a time period (e.g., number of days) it will take for the claim to be adjudicated (e.g., either paid or denied).

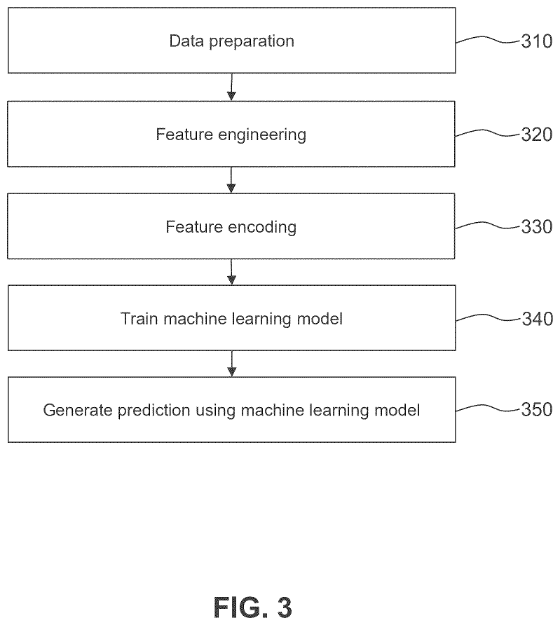

FIG. 3 is a flowchart illustrating process 300 for predicting a time to adjudication using a time to adjudication estimator, according to some embodiments. Process 300 shall be described with reference to FIG. 3, however, process 300 is not limited to that example embodiment.

Process 300 may be executed on any computing device, such as, for example, the exemplary computer system described with reference to FIG. 7. Process 300 may be performed by processing logic that may comprise hardware (e.g., circuitry, dedicated logic, programmable logic, microcode, etc.), software (e.g., instructions executing on a processing device), or a combination thereof.

In some embodiments, one or more of the steps shown in FIG. 3 may be omitted, repeated, performed simultaneously, and/or performed in a different order than the order shown in FIG. 3. Accordingly, the scope of the invention should not be considered limited to the specific arrangement of steps shown in FIG. 3. The steps shown in FIG. 3 may be implemented as computer-readable instructions stored on computer-readable media, where, when the instructions are executed, cause a processor to perform the process of FIG. 3.

At 310, the time to adjudication estimator performs a data preparation process by preparing input data. The models rely on clean, structured data with mandatory fields such as patient information, claim submission details, and billing records. The data preparation process may include: (1) data cleaning; (2) data type conversion; and (3) filtering. In some embodiments, the prepared input data is first received as a plurality of claims.

Data cleaning may involve adding missing entries and/or revising incomplete entries. For example, the time to adjudication estimator may require that fields such as “claimbilldate,” “dischargedate,” and “checkdate” fields must be present for accurate predictions. In some embodiments, the process 300 may terminate if a required field is missing.

Data type conversion may ensure that fields such as dates, numerical values, and categorical data are converted into appropriate formats. For instance, the time to adjudication estimator may convert date fields (e.g., “claimbilldate”) into date time objects. Similarly, the time to adjudication estimator may convert “chargeamount” data fields into floating-point numbers.

Filtering may involve removing data points based on comparing the data point to a predefined threshold. For example, the time to adjudication estimator may remove claims based on a determination that a time between when the claim was submitted and a current time is greater than predefined threshold. For example, claims submitted before 2020 may be removed, as they may not reflect current claim processing trends.

In some embodiments, to filter the data, such as a plurality of claims, one or more time fields of one or more claims of the plurality of claims are identified based on each time field meeting a pre-defined threshold. Furthermore, in such embodiments, the one or more claims corresponding to the identified one or more time fields may be removed from the plurality of claims. This filtering step may generate a filtered plurality of claims.

At 320, the time to adjudication estimator performs a feature engineering process. The time to adjudication estimator may extract features from the input data. Features may be key attributes of the data that the models use to make predictions. These features may fall into three categories: (1) numerical features; (2) categorical features; and (3) custom features.

Numerical features may include continuous data such as, but not limited to, “chargeamount” (an amount billed), “los” (length of stay), “ptage” (patient age), and “daystobill” (number of days from discharge to when the claim was billed).

Categorical features may include fields such as “facilitytype,” “typeofbill,” “ptsex” (patient sex), “primarydiagnosis,” and “currentpayertype.” Categorical data may be later transformed into numerical indices to be used by the time to adjudication estimator.

Custom features may include features generated by the time to adjudication estimator based on relationships between existing data. For example, “current_payer_ord” may be a custom ordinal feature representing whether the current payor is primary, secondary, or tertiary. “same_admit_dx” may be a custom feature represented as a binary value indicating if the admitting diagnosis matches the primary diagnosis. “is_dead” may be a custom feature represented by a binary value for whether the patient has passed away during or after treatment.

In some embodiments, a plurality of features may be extracted from the filtered plurality of claims. The plurality of features may include one or more numerical features, one or more categorical features, and/or one or more custom features. The one or more custom features may be features generated based on relationships between fields of the filtered plurality of claims.

At 330, the time to adjudication estimator performs a feature encoding process. For example, categorical features may be transformed into numerical representations. In some embodiments, the time to adjudication estimator may use an integer lookup that maps values of categorical features (e.g., “facilitytype,” “primarydiagnosis”) to unique indices. For example, a categorical features for “Facility Type” may include values such as “Hospital” and “Clinic.” Here, “Hospital” may be mapped to 1, and “Clinic” may be mapped to 2. Similarly, diagnosis codes may be shortened and mapped to unique numeric indices. This is beneficial for compatibility with the machine learning models. The time to adjudication estimator may then save the encoded features to ensure consistent mapping during prediction. In some embodiments, the time to adjudication estimator may save the encoded features in a data structure such as a dictionary. In some embodiments, a plurality of feature encodings may be generated corresponding to the plurality of features described in step 320.

At 340, the time to adjudication estimator trains a machine learning model. The time to adjudication estimator may train a model using historical claim data. The historical claim data may include the amount of time to adjudication for each claim. As noted above, the time to adjudication may be the amount of time to when the claim was paid or denied. The models learn by comparing predictions with the actual outcomes and adjusting internal parameters to improve accuracy. The time to adjudication machine learning model may use mean squared error (MSE) as the loss function. MSE is beneficial for regression tasks where the output is a continuous value (e.g., number of days). In some embodiments, the loss function may be, but is not limited to, median absolute error, Huber loss function, and asymmetric loss. In some embodiments, a machine learning model is trained on the filtered plurality of claims based on a loss function and/or the plurality of feature encodings.

At 350, the time to adjudication estimator generates a prediction using the machine learning model. The prediction may be based on new claim data. As noted above, the prediction may be an estimation of the number of days it will take for a claim to be adjudicated (either paid or denied). This helps providers anticipate delays and improve cash flow management.

As noted above, the denial suite may include a remark code prediction system. The denial remark code prediction system may be designed to predict specific denial remark codes associated with healthcare claim denials (e.g., C0-45: Charge higher than allowed; MA-31: No Medicare authorization; and N129: Service already paid). By focusing on the precise reason and remark codes, the denial suite enables healthcare providers to proactively address potential issues that lead to claim denials, thereby improving reimbursement rates and reducing administrative burdens.

The remark code prediction system may include a machine learning model configured to predict the likelihood of a healthcare claim being denied for a specific reason and an associated remark code. The remark code prediction system may utilize advanced feature engineering and a custom neural network to analyze patterns in historical claim data, focusing on outpatient claims and specific denial types.

In some embodiments, a time prediction is generated by inputting a claim into the trained machine learning model. The claim may be received at run-time. The time prediction may indicate a duration to adjudication corresponding to a submission of the claim. In some embodiments, steps 310-340 correspond to a training period or interval, and step 350 corresponds to a run-time operation of a system, such as a denial suite or a time to adjudication system.

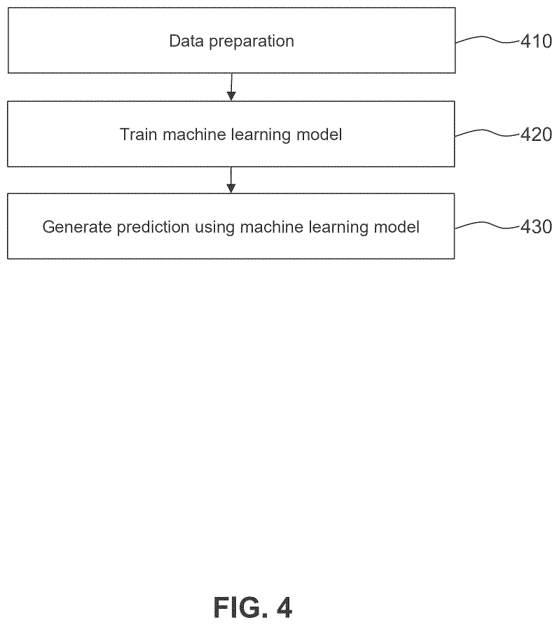

FIG. 4 is a flowchart illustrating process 400 for predicting a remark code using a remark code prediction system, according to some embodiments. Process 400 shall be described with reference to FIG. 4, however, process 400 is not limited to that example embodiment.

Process 400 may be executed on any computing device, such as, for example, the exemplary computer system described with reference to FIG. 7. Process 400 may be performed by processing logic that may comprise hardware (e.g., circuitry, dedicated logic, programmable logic, microcode, etc.), software (e.g., instructions executing on a processing device), or a combination thereof.

In some embodiments, one or more of the steps shown in FIG. 4 may be omitted, repeated, performed simultaneously, and/or performed in a different order than the order shown in FIG. 4. Accordingly, the scope of the invention should not be considered limited to the specific arrangement of steps shown in FIG. 4. The steps shown in FIG. 4 may be implemented as computer-readable instructions stored on computer-readable media, where, when the instructions are executed, cause a processor to perform the process illustrated in FIG. 4.

At 410, the remark code prediction system performs a data preparation process. The data preparation process may include a feature engineering process. Feature engineering may include: (1) current payor order; (2) diagnosis simplification; (3) comparative diagnosis indicators; (4) mortality indicators; and (5) days to bill calculation.

Current payor order may determine the position of the current payor (e.g., primary, secondary, tertiary) in the claim. Diagnosis simplification may truncate a diagnosis code to its first three characters to generalize and group similar diagnoses. Comparative diagnosis indicators may flag whether an admitting diagnosis matches a primary diagnosis. Mortality indicator may identify if the patient is deceased, which may affect claim processing. Days to bill calculation may calculate the number of days between discharge and claim billing dates.

The data preparation process may further include categorical feature encoding. Categorical feature encoding may organize categorical variables into groups based on their characteristics. For example, unique categorical values may be mapped to a numerical index for efficient processing. Categorical feature encoding may further handle missing or unknown values by assigning them special indices. Categorical feature encoding may further involve numerical feature standardization where continuous variables are scaled. Continuous variable examples may include, but are not limited to, charge amount, length of stay, and patient age.

At 420, the remark code prediction system trains a machine learning model. The remark code prediction system may chronologically split a dataset. The remark code prediction system may use data prior to a predefined date/time for training, and data after the predefined date/time for testing. The machine learning model may be a custom neural network model. The custom neural network model may include multiple input layers constructed to handle different types of data. For example, the custom neural network may be configured to process standardized numerical features. The custom neural network may be further configured to process categorical input data. Here, the custom neural network may process encoded categorical features using integer lookup layers and multi-hot encoding. The model architecture allows for hierarchical feature integration, capturing complex interactions between variables.

At 430, the remark code prediction system generates a denial remark code prediction. The trained model may predict the probability of each specific denial remark code associated with a claim. By focusing on precise reason and remark codes, the system provides actionable insights into why a claim might be denied. The remark code prediction system may implement threshold-based classification. Here, probabilities may be converted into binary predictions using a predefined threshold (e.g., 0.5). This classification may determine whether a claim is likely to be denied for specific remark codes.

As an example, a healthcare provider may prepare to submit outpatient claims for reimbursement. Historically, certain claims have been denied with reason code “16” and associated remark codes like “M20” (e.g., missing/incomplete/invalid healthcare common procedure coding system (HCPCS)). The remark code prediction system may filter claims with reason code “16” and prepare the data using the advanced feature engineering techniques. The model of the remark code prediction system may then analyze features such as the current payor order, diagnosis codes, patient demographics, and billing information. The model may then predict the likelihood of each remark code (“M20,” “M119,” “N245,” etc.) being associated with a denial. The remark code prediction system may then identify that claims with specific procedure codes and missing modifiers are at a higher risk of being denied with remark code “M20.” The healthcare provider may then review these claims before submission, ensuring that all required information is complete and accurate. This proactive approach reduces the chance of denial and improves the efficiency of the billing process.

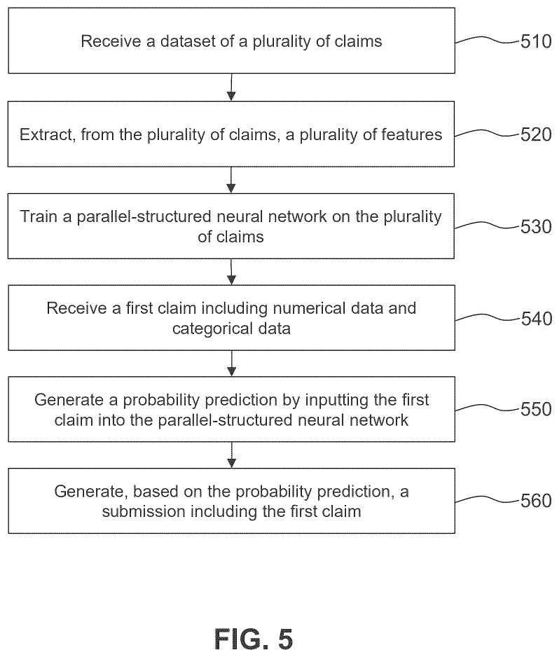

FIG. 5 is a flowchart illustrating process 500 for training and applying a parallel-structured neural network, according to some embodiments. Process 500 shall be described with reference to FIG. 5, however, process 500 is not limited to that example embodiment.

Process 500 may be executed on any computing device, such as, for example, the exemplary computer system described with reference to FIG. 7. Process 500 may be performed by processing logic that may comprise hardware (e.g., circuitry, dedicated logic, programmable logic, microcode, etc.), software (e.g., instructions executing on a processing device), or a combination thereof.

In some embodiments, one or more of the steps shown in FIG. 5 may be omitted, repeated, performed simultaneously, and/or performed in a different order than the order shown in FIG. 5. Accordingly, the scope of the invention should not be considered limited to the specific arrangement of steps shown in FIG. 5. The steps shown in FIG. 5 may be implemented as computer-readable instructions stored on computer-readable media, where, when the instructions are executed, cause a processor to perform the process of FIG. 5.

At 510, a dataset of a plurality of claims is received. Each claim of the plurality of claims may include a plurality of fields, such as any of the fields described herein.

At 520, a plurality of features are extracted from the plurality of claims. The extraction may be based on the plurality of fields and/or one or more feature engineering methods, such as any described herein. In some embodiments, the plurality of features includes a plurality of numerical features and a plurality of categorical features. In some embodiments, the plurality of features includes a plurality of custom features, generated based on relationships between fields of the plurality of claims.

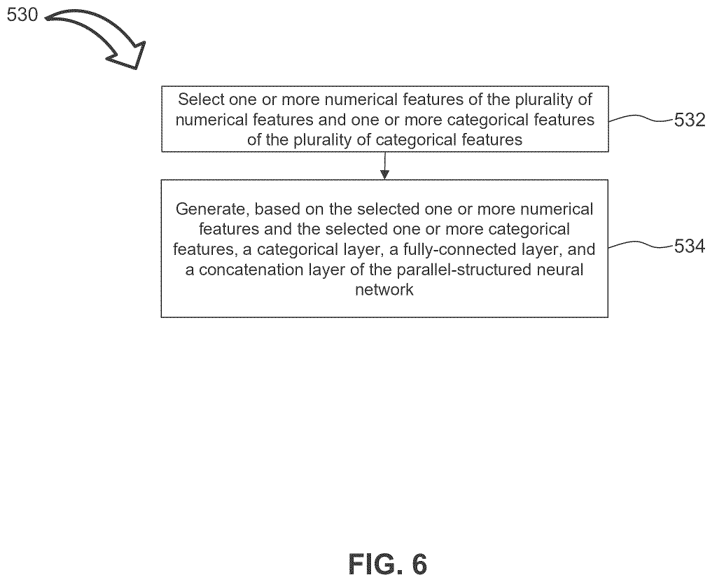

At 530, a parallel-structured neural network is trained on the plurality of claims. The training may be based on a feature selection algorithm and/or a loss function. In some embodiments, step 530 is performed by the steps of FIG. 6. At step 532, one or more numerical features of the plurality of numerical features and one or more categorical features of the plurality of categorical features may be selected. Such selection may be performed based on the feature selection algorithm and/or the loss function. At step 534, a categorical layer, a fully-connected layer, and a concatenation layer of the parallel-structured neural network may be generated. Such generation may be performed based on the selected one or more numerical features and the selected one or more categorical features.

At 540, a first claim including numerical data and categorical data may be received. In some embodiments, the first claim is received at run-time.

At 550, a probability prediction is generated by inputting the first claim into the parallel-structured neural network, as discussed further with respect to FIGS. 1 and 2.

In some embodiments, the first claim may be returned to a revision stage based on the probability prediction. For example, a system, such as a denial suite, may include one or more pre-defined thresholds corresponding to the probability prediction. In such an example, failure to satisfy the one or more pre-defined thresholds may cause the first claim to return to a revision stage and/or not continue process 500 to step 560.

In some embodiments, the categorical layer is configured to generate one or more vector embeddings corresponding to the one or more selected categorical features. The categorical layer may be configured to scale one or more inputted continuous features into one or more discretized values. The fully-connected layer may be configured to receive inputs corresponding to the one or more selected numerical features. The categorical layer and the fully-connected layer may be parallel layers of the parallel-structured neural network. The concatenation layer may be configured to concatenate outputs of the parallel layers of the neural network.

At 560, a submission including the first claim is generated based on the probability prediction. In some embodiments, the submission is generated in real-time and responsive to receiving the first claim at step 540.

In some embodiments, steps 510-530 correspond to a training period or interval, and steps 540-560 correspond to a run-time operation of a system, such as a denial suite system.

In some embodiments, after step 560, a denial indication corresponding to the first claim and/or the submission may be received. In such embodiments, a second probability prediction may be generated by inputting the first claim into a second parallel-structured neural network. The second parallel-structured neural network may be trained on a plurality of resubmitted claims and/or be configured to determine a likelihood of success for a resubmitted claim.

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof. Computer system 700 may be used to implement systems 100A, 100B, 200, and 300. For example, computer system 700 may be used to implemented resource allocation platform 130 and process resource allocation requests.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, the embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, the embodiments (whether or not explicitly described herein) have significant utility to fields and applications beyond the examples described herein.

The embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for training and applying a parallel-structured neural network, the method comprising:
receiving a dataset of a plurality of claims, wherein each claim of the plurality of claims includes a plurality of fields;
extracting, from the plurality of claims and based on the plurality of fields, a plurality of features, wherein the plurality of features includes a plurality of numerical features and a plurality of categorical features;
training, based on a feature selection algorithm and a loss function, the parallel-structured neural network on the plurality of claims, wherein the training is performed by:
selecting, based on the feature selection algorithm and the loss function, one or more numerical features of the plurality of numerical features and one or more categorical features of the plurality of categorical features; and
generating, based on the selected one or more numerical features and the selected one or more categorical features, a categorical layer, a fully-connected layer, and a concatenation layer of the parallel-structured neural network;
receiving a first claim including numerical data and categorical data;
generating a probability prediction by inputting the first claim into the parallel-structured neural network; and
generating, based on the probability prediction, a submission including the first claim.

2. The computer-implemented method of claim 1, further comprising:
returning, based on the probability prediction, the first claim to a revision stage.

3. The computer-implemented method of claim 1, further comprising:
receiving a denial indication corresponding to the first claim; and
generating a second probability prediction by inputting the first claim into a second parallel-structured neural network, wherein the second parallel-structured neural network is trained on a plurality of resubmitted claims.

4. The computer-implemented method of claim 1, further comprising:
receiving a second dataset of a second plurality of claims;
filtering the second plurality of claims by:
identifying one or more time fields of one or more claims of the second plurality of claims, based on each time field of the one or more time fields meeting a predefined threshold; and
removing the one or more claims of the second plurality of claims from the second plurality of claims;
extracting, from the filtered second plurality of claims, a second plurality of features, wherein the second plurality of features includes one or more second numerical features, one or more second categorical features, and one or more custom features, wherein the one or more custom features are generated based on relationships between fields of the filtered second plurality of claims;
generating a plurality of feature encodings corresponding to the second plurality of features;
training, based on a second loss function and the plurality of feature encodings, a machine learning model on the filtered second plurality of claims; and
generating a time prediction by inputting the first claim into the machine learning model, wherein the time prediction indicates a duration to adjudication corresponding to the submission including the first claim.

5. The computer-implemented method of claim 1, further comprising:
generating a clean plurality of claims by adding one or more required fields to a subset of claims of the plurality of claims, wherein each claim of the subset of claims is missing the one or more required fields; and
generating a standardized plurality of claims by converting one or more fields of one or more claims of the clean plurality of claims to a standardized format.

6. The computer-implemented method of claim 1, wherein:
the categorical layer is configured to generate one or more vector embeddings corresponding to the one or more selected categorical features,
the fully-connected layer is configured to receive inputs corresponding to the one or more selected numerical features,
the categorical layer and the fully-connected layer are parallel layers of the parallel-structured neural network, and
the concatenation layer is configured to concatenate outputs of the parallel layers.

7. The computer-implemented method of claim 1, wherein the categorical layer is configured to scale one or more continuous features of the categorical data.

8. A system for training and applying a parallel-structured neural network, comprising:
a memory; and
at least one processor coupled to the memory and configured to:
receive a dataset of a plurality of claims, wherein each claim of the plurality of claims includes a plurality of fields;
extract, from the plurality of claims and based on the plurality of fields, a plurality of features, wherein the plurality of features includes a plurality of numerical features and a plurality of categorical features;
train, based on a feature selection algorithm and a loss function, the parallel-structured neural network on the plurality of claims, wherein the at least one processor is further configured to:
select, based on the feature selection algorithm and the loss function, one or more numerical features of the plurality of numerical features and one or more categorical features of the plurality of categorical features; and
generate, based on the selected one or more numerical features and the selected one or more categorical features, a categorical layer, a fully-connected layer, and a concatenation layer of the parallel-structured neural network;
receive a first claim including numerical data and categorical data;
generate a probability prediction by inputting the first claim into the parallel-structured neural network; and
generate, based on the probability prediction, a submission including the first claim.

9. The system of claim 8, the at least one processor further configured to:
return, based on the probability prediction, the first claim to a revision stage.

10. The system of claim 8, the at least one processor further configured to:
receive a denial indication corresponding to the first claim; and
generate a second probability prediction by inputting the first claim into a second parallel-structured neural network, wherein the second parallel-structured neural network is trained on a plurality of resubmitted claims.

11. The system of claim 8, the at least one processor further configured to:
receive a second dataset of a second plurality of claims;
filter the second plurality of claims by, wherein the at least one processor is further configured to:
identify one or more time fields of one or more claims of the second plurality of claims, based on each time field of the one or more time fields meeting a predefined threshold; and
remove the one or more claims of the second plurality of claims from the second plurality of claims;
extract, from the filtered second plurality of claims, a second plurality of features, wherein the second plurality of features includes one or more second numerical features, one or more second categorical features, and one or more custom features, wherein the one or more custom features are generated based on relationships between fields of the filtered second plurality of claims;
generate a plurality of feature encodings corresponding to the second plurality of features;
train, based on a second loss function and the plurality of feature encodings, a machine learning model on the filtered second plurality of claims; and
generate a time prediction by inputting the first claim into the machine learning model, wherein the time prediction indicates a duration to adjudication corresponding to the submission including the first claim.

12. The system of claim 8, the at least one processor further configured to:
generate a clean plurality of claims by adding one or more required fields to a subset of claims of the plurality of claims, wherein each claim of the subset of claims is missing the one or more required fields; and
generate a standardized plurality of claims by converting one or more fields of one or more claims of the clean plurality of claims to a standardized format.

13. The system of claim 8, wherein:
the categorical layer is configured to generate one or more vector embeddings corresponding to the selected one or more categorical features,
the fully-connected layer is configured to receive inputs corresponding to the selected one or more numerical features,
the categorical layer and the fully-connected layer are parallel layers of the parallel-structured neural network, and
the concatenation layer is configured to concatenate outputs of the parallel layers.

14. The system of claim 8, wherein the categorical layer is configured to scale one or more continuous features of the categorical data.

15. A non-transitory computer-readable medium having instructions stored thereon that, when executed by at least one computing device, cause the at least one computing device to perform operations for training and applying a parallel-structured neural network, the operations comprising:
receiving a dataset of a plurality of claims, wherein each claim of the plurality of claims includes a plurality of fields;
extracting, from the plurality of claims and based on the plurality of fields, a plurality of features, wherein the plurality of features includes a plurality of numerical features and a plurality of categorical features;
training, based on a feature selection algorithm and a loss function, the parallel-structured neural network on the plurality of claims, wherein the training is performed by:
selecting, based on the feature selection algorithm and the loss function, one or more numerical features of the plurality of numerical features and one or more categorical features of the plurality of categorical features; and
generating, based on the selected one or more numerical features and the selected one or more categorical features, a categorical layer, a fully-connected layer, and a concatenation layer of the parallel-structured neural network;
receiving a first claim including numerical data and categorical data;
generating a probability prediction by inputting the first claim into the parallel-structured neural network; and
generating, based on the probability prediction, a submission including the first claim.

16. The non-transitory computer-readable medium of claim 15, the operations further comprising:
returning, based on the probability prediction, the first claim to a revision stage.

17. The non-transitory computer-readable medium of claim 15, the operations further comprising:
receiving a denial indication corresponding to the first claim; and
generating a second probability prediction by inputting the first claim into a second parallel-structured neural network, wherein the second parallel-structured neural network is trained on a plurality of resubmitted claims.

18. The non-transitory computer-readable medium of claim 15, the operations further comprising:
receiving a second dataset of a second plurality of claims;
filtering the second plurality of claims by:
identifying one or more time fields of one or more claims of the second plurality of claims, based on each time field of the one or more time fields meeting a predefined threshold; and
removing the one or more claims of the second plurality of claims from the second plurality of claims;
extracting, from the filtered second plurality of claims, a second plurality of features, wherein the second plurality of features includes one or more second numerical features, one or more second categorical features, and one or more custom features, wherein the one or more custom features are generated based on relationships between fields of the filtered second plurality of claims;
generating a plurality of feature encodings corresponding to the second plurality of features;
training, based on a second loss function and the plurality of feature encodings, a machine learning model on the filtered second plurality of claims; and
generating a time prediction by inputting the first claim into the machine learning model, wherein the time prediction indicates a duration to adjudication corresponding to the submission including the first claim.

19. The non-transitory computer-readable medium of claim 15, the operations further comprising:
generating a clean plurality of claims by adding one or more required fields to a subset of claims of the plurality of claims, wherein each claim of the subset of claims is missing the one or more required fields; and
generating a standardized plurality of claims by converting one or more fields of one or more claims of the clean plurality of claims to a standardized format.

20. The non-transitory computer-readable medium of claim 15, wherein:
the categorical layer is configured to generate one or more vector embeddings corresponding to the selected one or more categorical features,
the fully-connected layer is configured to receive inputs corresponding to the selected one or more numerical features,
the categorical layer and the fully-connected layer are parallel layers of the parallel-structured neural network, and
the concatenation layer is configured to concatenate outputs of the parallel layers.
